(19) United States
(12) Patent Application Publication
(10) Pub. No.: US 2025/0218036 A1
(43) Pub. Date: Jul. 3, 2025

(54) IMAGE PROCESSING METHOD, VEHICLE-MOUNTED DEVICE AND STORAGE MEDIUM

(71) Applicant: HON HAI PRECISION INDUSTRY CO., LTD., New Taipei (TW)

(72) Inventors: LI-CHE LIN, Kaohsiung (TW); Cheng-Feng Wang, Kaohsiung (TW)

(21) Appl. No.: 19/001,716

(22) Filed: Dec. 26, 2024

(30) Foreign Application Priority Data
Dec. 29, 2023 (CN) 202311873203.7

(51) Int. Cl. G06T 7/73; G06T 7/11; G06T 11/00

(52) U.S. Cl. CPC G06T 7/74; G06T 7/11; G06T 11/00; G06T 2207/20068; G06T 2207/20132; G06T 2207/30252

(57) ABSTRACT

An image processing method applied to a vehicle-mounted device is provided. The vehicle-mounted device obtains a first image of a front part of and a second image of a rear part of the external vehicle and obtains several spatial coordinates of several vertices of the target visual plane. The device projects each of the spatial coordinate into a first coordinate system of the first image and a second coordinate system of the second image and obtains a first projection coordinate and a second projection coordinate, generates a first transformation matrix or a second transformation matrix according to the first projection coordinate and the second projection coordinate, and obtains a first conversion image corresponding to the first image, or a second conversion image corresponding to the second image; and generates an image of a whole body of the external vehicle based on the first converted image and the second image.

### FIELD

The present disclosure relates to a field of intelligent driving technology, in particular to an image processing method, a vehicle-mounted device, and a storage medium.

### BACKGROUND

As a vehicle is being driven, for the sake of safe and intelligent driving, images of other vehicles out of the vehicle are often obtained through a camera device installed on the vehicle. However, due to limitations of factors such as location of the camera device and shooting angle, the images may only include part of the body of the other vehicles. In related technologies, a vehicle-mounted device may detect the images include only part of the body of the other vehicles directly and track the other vehicles according to a detection result (such as color of the other vehicles, types of the other vehicles and other vehicle information). As the images lack some information of the other vehicle, directly detecting the images include only part of the body of the other vehicles may lead to an inaccurate detection result, thus affecting tracking effect of the other vehicles.

### BRIEF DESCRIPTION OF THE DRAWINGS

FIG. 1 is a schematic structural diagram of a vehicle-mounted device provided by an embodiment of the present application.

FIG. 2 is a flowchart of an image processing method provided by an embodiment of the present application.

FIG. 3 is a schematic diagram of a first image of a front part of a vehicle provided by an embodiment of the present application.

FIG. 4 is a schematic diagram of a second image of a rear part of a vehicle provided by an embodiment of the present application.

FIG. 5 is a schematic diagram of a first projection plane provided by an embodiment of the present application.

FIG. 6 is a schematic diagram of a second projection plane provided by an embodiment of the present application.

FIG. 7 is a schematic diagram of a cropped image provided by an embodiment of the present application.

FIG. 8 is a schematic diagram of an image of a whole body of an external vehicle provided by an embodiment of the present application.

FIG. 9 is a schematic diagram of an area of a whole body of a vehicle provided by an embodiment of the present application.

FIG. 10 is a flowchart of a method for calculating a first transformation matrix provided by an embodiment of the present application.

### DETAILED DESCRIPTION

It should be noted that in the present application, “at least one” refers to one or more, and “a plurality of” refers to two or more than two. “And/or” describes a relationship between related objects and may indicate three types of relationships. For example, A and/or B may mean: A exists alone, A and B exist simultaneously, and B exists alone, wherein A and B may be singular or plural. The terms “first”, “second”, “third”, “fourth”, etc. (if present) in the description, claims and drawings of the present application are used to distinguish similar objects, rather than to describe a specific order or a sequence.

In the embodiments of the present application, words such as “exemplary” or “for example” are used to represent examples, illustrations or explanations. Any embodiment or design described as “exemplary” or “such as” in the embodiments of the present application should not be construed as being preferred or adding advantage over other embodiments or designs. It is intended that the use of the words “exemplary” or “such as” is intended to convey the concept in a concrete manner.

During a vehicle is driving, for the sake of safe and intelligent driving, images of other vehicles out of the vehicle are often obtained through a camera device installed on the vehicle. However, due to limitations of factors such as location of the camera device and shooting angle, the images may only include part of the body of the other vehicles. In related technologies, a vehicle-mounted device may detect the images include only part of the body of the other vehicles directly and track the other vehicles according to a detection result (such as color of the other vehicles, types of the other vehicles and other vehicle information). As the images lack of some information of the other vehicle, directly detecting the images include only part of the body of the other vehicles may lead to an inaccurate detection result, thus affecting tracking effect of the other vehicles.

In order to solve the above problems, an embodiment of the present disclosure provides an image processing method, a vehicle-mounted device and a storage medium that may generate an image with a whole body of a vehicle, thereby ensuring an accuracy of a result for detecting a vehicle and an effect for tacking the vehicle. The method for processing image provided by the embodiment of the present application may be applied to one or more vehicle-mounted devices.

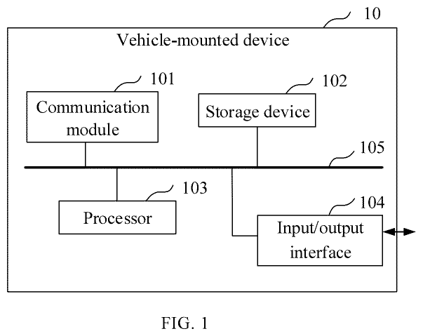

As shown in FIG. 1, it is a schematic structural diagram of a vehicle-mounted device provided by an embodiment of the present application. The vehicle-mounted device 10 may be a device such as an electronic control unit (ECU) or a body control module (BCM). The embodiment of the present application does not place any restrictions on the specific type of the vehicle-mounted device.

As shown in FIG. 1, the vehicle-mounted device 10 may include a communication module 101, a storage device 102, a processor 103, an input/output (I/O) interface 104 and a bus 105. The processor 103 is coupled to the communication module 101, the storage device 102, and the input/output interface 104 through the bus 105, respectively.

The communication module 101 may include a wired communication module and/or a wireless communication module. The wired communication module may provide one or more of the wired communication solutions, such as universal serial bus (USB), controller area network (MAY), local interconnect network (LIN) and flexible network bus (FlexRay). The wireless communication module may provide one or more of the wireless communication solutions such as wireless fidelity (Wi-Fi), Bluetooth (BT), mobile communication network, frequency modulation (FM), near field communication (NFC), and infrared (IR) technology.

The storage device 102 may include one or more random access memories (RAM) and one or more non-volatile memories (NVM). The random access memory may be directly read and written by the processor 103, and may be used to store executable programs (such as machine instructions) or other running programs, and may also be used to store data of a user and an application, etc. The random access memory may include static random-access memory (SRAM), dynamic random access memory (DRAM), synchronous dynamic random access memory (SDRAM), double data rate synchronous dynamic random access memory (DDR SDRAM), etc.

The non-volatile memory may also store executable programs and data of the user and the application, etc., and may be loaded into the random-access memory in advance for direct reading and writing by processor 103. Non-volatile memory may include disk storage devices and flash memory.

The storage device 102 is used to store one or more computer programs. One or more computer programs are configured for execution by processor 103. The one or more computer programs include a plurality of instructions. When the plurality of instructions is executed by processor 103, the method for processing image executed on the vehicle-mounted device 10 may be implemented.

In other embodiments, the vehicle-mounted device 10 shown in FIG. 1 also includes an external memory interface for connecting to an external memory to expand the storage capacity of the vehicle-mounted device 10.

The processor 103 may include one or more processing units. For example, the processor 103 may include an application processor (AP), a modem processor, a graphics processing unit (GPU), and an image signal processor (ISP), a controller, a video codec, a digital signal processor (DSP), and/or a neural network processor (NPU), etc. Among them, different processing units may be independent devices or integrated in one or more processors.

The processor 103 provides capabilities of calculating and controlling. For example, the processor 103 is used to execute a computer program stored in the storage device 102 to implement the above image processing method.

The input/output interface 104 is used to provide a channel for inputting information by the user or outputting information to the user. For example, the input/output interface 104 may be used to connect various input and output devices, such as a mouse, a keyboard, a touch device, a display screen, etc., so that the user may input information, or the input/output interface 104 makes the information visualize.

The bus 105 at least used to provide a channel for mutual communication among the communication module 101, the storage device 102, the processor 103, and the input/output interface 104 of the vehicle-mounted device 10.

It may be understood that the structure illustrated in the embodiment of the present application does not constitute a specific limitation on the vehicle-mounted device 10. In other embodiments of the present application, the vehicle-mounted device 10 may include more or less components than shown in the figures, or some components may be combined, or some components may be separated, or may be arranged differently. The components illustrated may be implemented in hardware, software, or a combination of software and hardware.

In other embodiments of the present application, the vehicle-mounted device 10 may also be replaced by an electronic device that may realize vehicle control. Electronic devices include, but are not limited to, mobile phones, tablets, laptops, computers, etc. The present application does not limit the electronic devices.

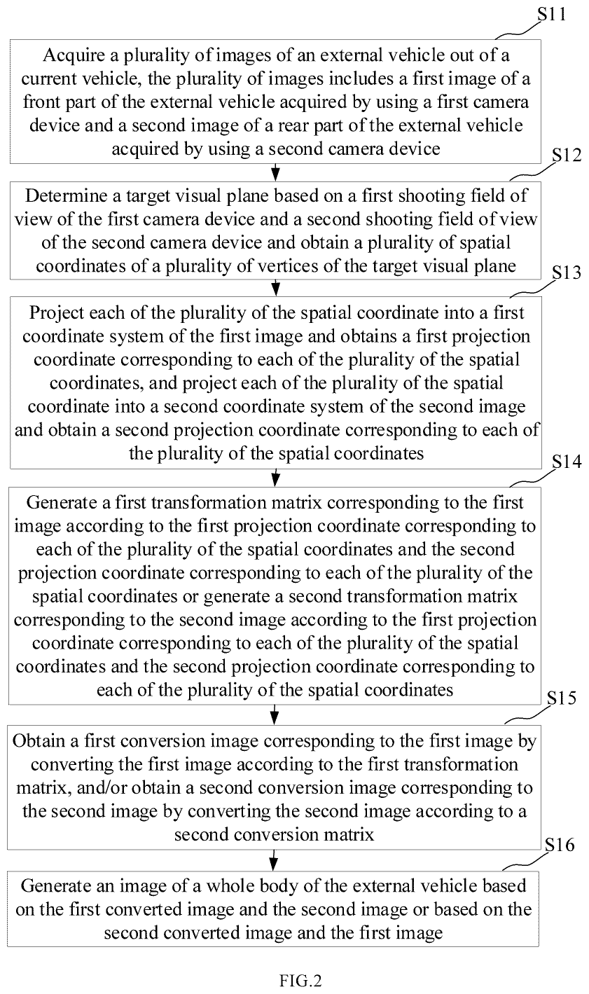

As shown in FIG. 2, it is a flowchart of an image processing method provided by an embodiment of the present application. According to different needs, the sequence of each step in this flowchart may be adjusted according to actual requirements, and some steps may be omitted. As an example, the method is applied to a vehicle-mounted device in a vehicle, such as the vehicle-mounted device 10 shown in FIG. 1.

In block S11, the vehicle-mounted device acquires a plurality of images of an external vehicle out of a current vehicle, the plurality of images includes a first image of a front part of the external vehicle acquired by using a first camera device and a second image of a rear part of the external vehicle acquired by using a second camera device.

In some embodiments of the present application, the vehicle to which the method is applied may be the current vehicle, and the vehicles out of the current vehicle may be the external vehicle. This application does not limit the external vehicle. The first camera device and the second camera device may be cameras equipped on both sides of the vehicle (for example, the above-mentioned vehicle). This application does not limit the specific types of the first camera device and the second camera device. A first view angle of the first camera device is different from a second view angle of the second camera device, and a first shooting field of view of the first camera device is different from a second shooting field of view of the second camera device.

In some embodiments of the present application, the vehicle-mounted device controls the first camera device to photograph the external vehicle from a first view angle to obtain the first image and controls the second camera device to photograph the external vehicle from a second view angle to obtain the second image.

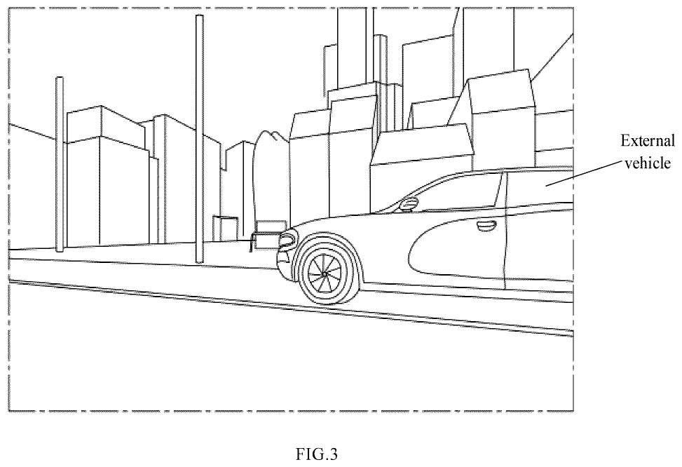

For example, as shown in FIG. 3, it is a schematic diagram of a first image of a front part of a vehicle provided by an embodiment of the present application. The first image in FIG. 3 is an image of the front part of the vehicle obtained by the vehicle-mounted device controlling the camera on the right rear side of the vehicle to shoot the external vehicle. As shown in FIG. 4, it is a schematic diagram of a second image of a rear part of a vehicle provided by an embodiment of the present application. The second image in FIG. 4 is an image of the rear part of the vehicle obtained by the vehicle-mounted device controlling the camera on the right front side of the vehicle to shoot the external vehicle.

In block S12, the vehicle-mounted device determines a target visual plane based on a first shooting field of view of the first camera device and a second shooting field of view of the second camera device and obtains a plurality of spatial coordinates of a plurality of vertices of the target visual plane.

In some embodiments of the present application, the target visual plane may be in an overlapping space area between the first shooting field of view of the first camera device corresponding to the first image and the second shooting field of view of the second camera device corresponding to the second image. The shape of the target view plane may be rectangular. In practical applications, the above examples are not limited.

In some embodiments of the present application, the vehicle-mounted device may determine a rectangular plane as the target visual plane in the overlapping space area of the first shooting field of view and the second shooting field of view, and the coordinates of a plurality of vertices of the target visual plane may be the four spatial coordinates of the four vertices of the rectangular plane. For example, the target visual plane includes four vertices A, B, C, and D. The spatial coordinates of the vertices A is A (1, 4.5, 0), the spatial coordinates of the vertices B is B (1, 4.5, 1.6), the spatial coordinates of the vertices C is C (−1, 4.5, 0), and the spatial coordinates of the vertices D is D (−1, 4.5, 1.6).

In block S13, the vehicle-mounted device projects each of the plurality of the spatial coordinate into a first coordinate system of the first image and obtains a first projection coordinate corresponding to each of the plurality of the spatial coordinates, and projects each of the plurality of the spatial coordinate into a second coordinate system of the second image and obtains a second projection coordinate corresponding to each of the plurality of the spatial coordinates.

In some embodiments of the present application, the vehicle-mounted device projects each spatial coordinate into the first coordinate system of the first image and obtains the first projection coordinate corresponding to the spatial coordinate includes: the vehicle-mounted device uses an orthogonal projection method or a perspective projection method to project each spatial coordinate into the first coordinate system of the first image, and obtain the first projection coordinate corresponding to the spatial coordinate.

In some embodiment, the first coordinate system of the first image may be an image coordinate system or a pixel coordinate system, which is not limited in this application. The first projection coordinate corresponding to each spatial coordinate of the pixel coordinate system of the first image is a two-dimensional coordinate.

For example, the vehicle-mounted device may establish the image coordinate system by taking a geometric center point of the first image as an origin, a straight line passing through the origin and parallel to a first row of pixels of the first image as the x-axis, and a straight line passing through the origin and parallel to a first column of pixels of the first image as the y-axis. The vehicle-mounted device may establish the pixel coordinate system by taking a pixel of a first row and a first column of the first image as an origin, a first row of pixels of the first image as the x-axis, and a first column of pixels of the first image as the y-axis.

In other embodiments of this application, the vehicle-mounted device may project each spatial coordinate to the coordinate system of the first image through other methods. This application does not limit the projection method.

In some embodiments of the present application, a generation process of the second projected coordinates is basically the same as a generation process of the first projected coordinates, so the description will not be repeated in this application.

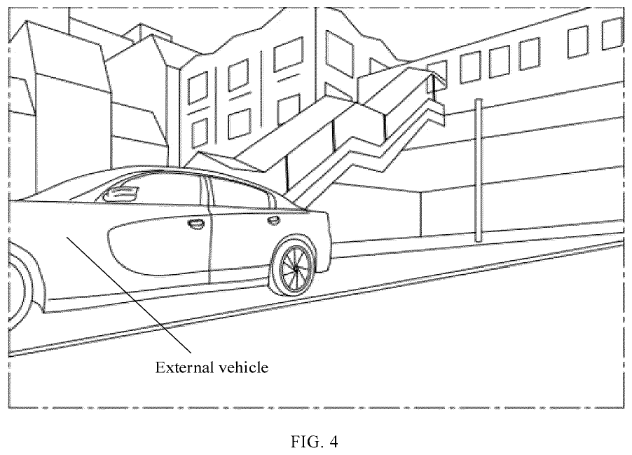

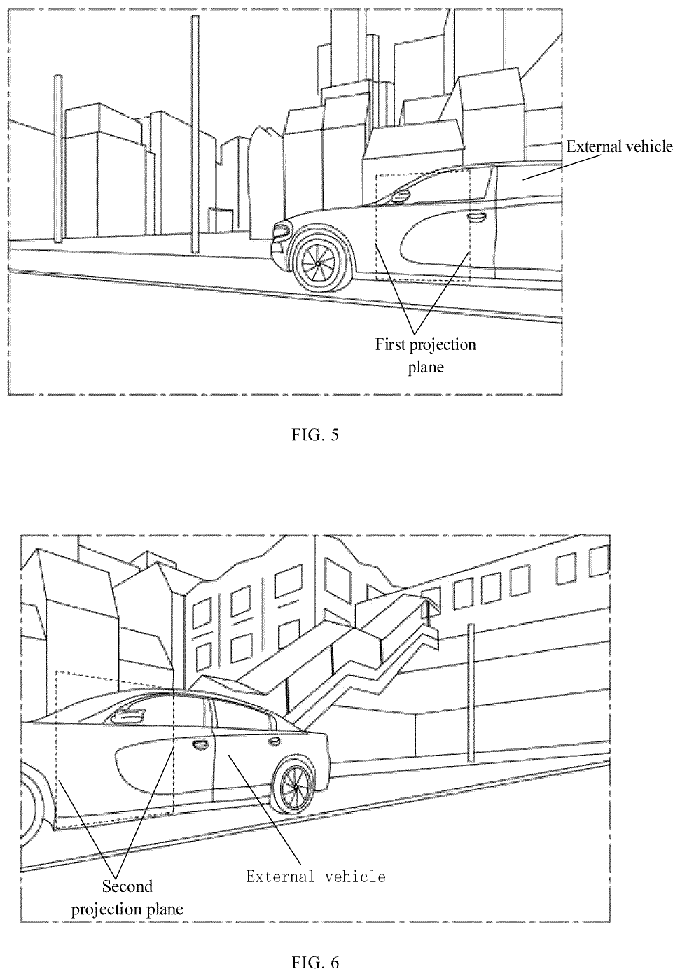

In this embodiment, a plurality of first projection coordinates may constitute a first projection plane corresponding to the target visual plane in the first image, and a plurality of second projection coordinates may constitute a second projection plane corresponding to the target visual plane in the second image. For example, as shown in FIG. 5, it is a schematic diagram of a first projection plane provided by an embodiment of the present application. The rectangular area indicated by dotted lines in FIG. 5 is the first projection plane. As shown in FIG. 6, it is a schematic diagram of the second projection plane provided by an embodiment of the present application. The rectangle indicated by a dotted line in FIG. 6 is the second projection plane. It may be seen from FIG. 5 and FIG. 6 that the position of the first projection plane in the vehicle body of the first image is the same as the position of the second projection plane in the vehicle body of the second image.

In block S14, the vehicle-mounted device generates a first transformation matrix corresponding to the first image according to the first projection coordinate corresponding to each of the plurality of the spatial coordinates and the second projection coordinate corresponding to each of the plurality of the spatial coordinates or generating a second transformation matrix corresponding to the second image according to the first projection coordinate corresponding to each of the plurality of the spatial coordinates and the second projection coordinate corresponding to each of the plurality of the spatial coordinates.

In some embodiments of the present application, the vehicle-mounted device generates the first transformation matrix corresponding to the first image based on the first projection coordinate corresponding to each spatial coordinate and the second projection coordinate corresponding to each spatial coordinate, including: the vehicle-mounted device multiplies a first homogeneous coordinate vector of each first projection coordinate with a preset parameter matric and obtains a multiplication vector of each first projection coordinate, and generates the first transformation matrix based on the multiplication vector and a second homogeneous coordinate vector of the second projection coordinate corresponding to the multiplication vector.

In one embodiment, the preset parameter matrix includes a plurality of parameters, and the preset parameter matrix may be a 3×3 matrix. For example, the preset parameter matrix may be

$$[ \begin{matrix}a & b & c \\ d & e & f \\ g & h & i\end{matrix} ] .$$

The first homogeneous coordinate vector of each first projected coordinate is a vector generated based on the corresponding first projected coordinate and the value “1”. For example, the first projected coordinate is (u₁, v₁) and the corresponding first homogeneous coordinate vector

$$[ \begin{matrix}{u}_{1} \\ {v}_{1} \\ 1\end{matrix} ] .$$

The generation process of the second homogeneous coordinate vector of each second projected coordinate is basically the same as the generation process of the first homogeneous coordinate vector and will not be described again in this application. The second projection coordinate corresponding to the multiplication vector of any first projection coordinate is the second projection coordinate generated by the projection of the spatial coordinate corresponding to any first projection coordinate.

In this embodiment, the first conversion matrix is a matrix that converts the shooting angle of view of the first camera device to the shooting angle of view of the second camera device.

In other embodiments of the present application, the vehicle-mounted device generating the second transformation matrix corresponding to the lower body image based on the first projection coordinate and the second projection coordinate corresponding to each spatial coordinate includes: the vehicle-mounted device converts the third projection coordinate of each second projection coordinate. The two homogeneous coordinate vectors are multiplied by the preset parameter matrix to obtain the product vector of each second projected coordinate, and the second transformation matrix is generated based on the product vector and the first homogeneous coordinate vector of the first projected coordinate corresponding to the product vector.

Wherein, the first projection coordinate corresponding to the product vector of any second projection coordinate is the first projection coordinate generated by the projection of the spatial coordinate corresponding to any second projection coordinate. The generation process of the product vector is basically the same as the generation process of the multiplication vector. The process of generating the second transformation matrix based on the product vector and the first homogeneous coordinate vector of the first projected coordinate corresponding to the product vector is the same as the process of generating the second transformation matrix based on the multiplication vector and the multiplication vector. The process of generating the first transformation matrix from the second homogeneous coordinate vector corresponding to the second projected coordinate is basically the same, so the description will not be repeated in this application.

In this embodiment, the second conversion matrix is a matrix that converts the first view angle of the first camera device to the second view angle of the second camera device.

In block S15, the vehicle-mounted device obtains a first conversion image corresponding to the first image by converting the first image according to the first transformation matrix, and/or obtains a second conversion image corresponding to the second image by converting the second image according to a second conversion matrix.

In some embodiments of the present application, the vehicle-mounted device converts the first image according to the first transformation matrix and obtains the first conversion image corresponding to the first image includes: the vehicle-mounted device multiplies a homogeneous coordinate vector corresponding to a first initial value of each pixel of the first image by the first transformation matrix and determines a first target coordinate corresponding to each first initial coordinate, and replaces a pixel value of a pixel of each first target coordinate of the first image with a pixel value of a pixel of the corresponding to the first initial coordinate and obtains the first converted image.

In one embodiment, the method of generating the homogeneous coordinate vector corresponding to each first initial coordinate may refer to the method of generating the first homogeneous coordinate vector mentioned above.

In this embodiment, the first image is converted through the first transformation matrix, so that the first converted image is equivalent to the first image obtained by the second camera device after extending the second camera device.

In other embodiments of the present application, the vehicle-mounted device converts the second image according to a second conversion matrix and obtains a second conversion image corresponding to the second image includes: the vehicle device converts multiplies a homogeneous coordinate vector corresponding to a second initial value of each pixel of the second image by the second transformation matrix and obtains a second target coordinate corresponding to each second initial coordinate, and replaces a pixel value of a pixel of each second target coordinate of the second image with a pixel value of a pixel of the corresponding to the second initial coordinate and obtains the second converted image.

In one embodiment, the method of generating the homogeneous coordinate vector corresponding to each first initial coordinate may refer to the method of generating the first homogeneous coordinate vector mentioned above.

the second initial value of each pixel in the lower body image. The homogeneous coordinate vector corresponding to the coordinate is multiplied by the second transformation matrix to obtain the second target coordinate corresponding to each second initial coordinate, and the pixel value of the pixel point on each second target coordinate is obtained in the lower body image. Replace it with the pixel value of the corresponding pixel point on the second initial coordinate to obtain the second converted image.

In this embodiment, the second image is converted through the second transformation matrix, so that the second converted image is equivalent to the second image obtained by the first camera device after extending the first camera device.

In Block S16, the vehicle-mounted device generates an image of a whole body of the external vehicle based on the first converted image and the second image or based on the second converted image and the first image.

In some embodiments of the present application, the vehicle-mounted device generates the image of the whole body of the external vehicle based on the first converted image and the second image includes: the vehicle-mounted device crops a first overlapping area between the first converted image and the second image from the first converted image and obtains a first cropped image, and splices the first cropped image and the second image and obtains the image of the whole body of the external vehicle.

In this embodiment, the vehicle-mounted device may detect the first overlapping area between the first converted image and the second image through a preset algorithm. For example, the preset algorithm may be an edge detection algorithm.

In this embodiment, the image of the whole body of the external vehicle, which is captured by the second camera device with the second view angle, may be generated according to the first converted image and the second image.

In other embodiments of the present application, the vehicle-mounted device generates the image of the whole body of the external vehicle based on the second converted image and the first image includes: the vehicle-mounted device crops a second overlapping area between the second converted image and the first image from the second converted image and obtains a second cropped image, and splices the second cropped image and the first image and obtains the image of the whole body of the external vehicle.

The generation process of the second overlapping area is basically the same as the generation process of the first overlapping area, so this application will not repeat the description here.

In this embodiment, the image of the whole body of the external vehicle, which captured by the first camera device with the first view angle, may be generated according to the second converted image and the first image.

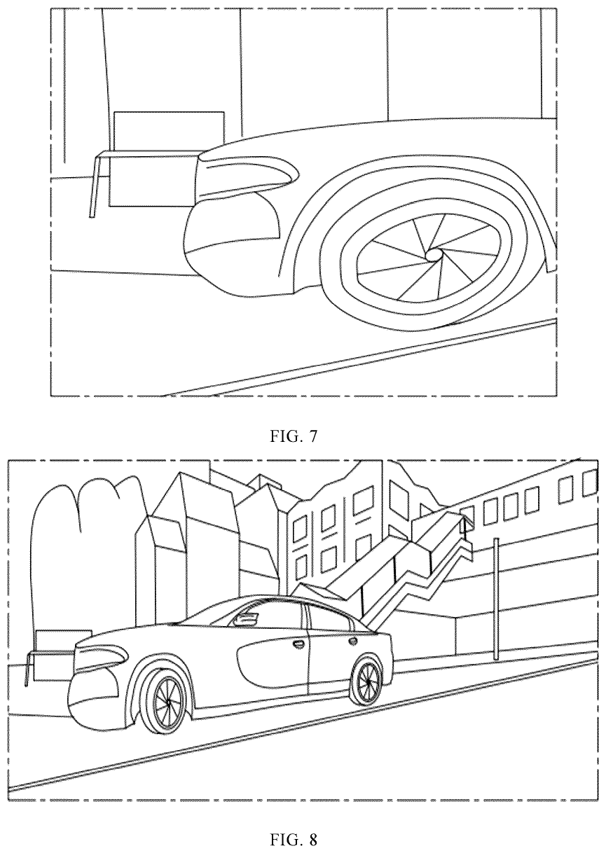

For example, as shown in FIG. 7, it is a schematic diagram of a cropped image provided by an embodiment of the present application. FIG. 7 is a cropped image obtained after cropping out the first overlapping area between the first converted image and the second image from the first converted image. For example, as shown in FIG. 8, it is a schematic diagram of an image of a whole body of a vehicle provided by an embodiment of the present application. FIG. 8 shows the image of the whole body of the vehicle obtained by splicing the cropped image in FIG. 7 and the second image. It may be seen from FIG. 8 that image of the whole body of the vehicle includes a whole body of the external image.

In some embodiments of the present application, after obtaining the image of the whole body of the vehicle, the vehicle-mounted device may invoke a target detection model to detect the image of the whole body of the vehicle and obtain coordinates of the external vehicle of the image of the whole body of the vehicle and vehicle information of the external vehicle.

Among them, the target detection model may be set by a user, and this application does not impose restrictions on this. For example, the target detection model may be a convolutional neural network model (CNN) with the VGG network as the backbone network. The target detection model may be obtained through pre-training. The vehicle information includes, but is not limited to, a type of the external vehicle, color of the external vehicle, size of the external vehicle, etc.

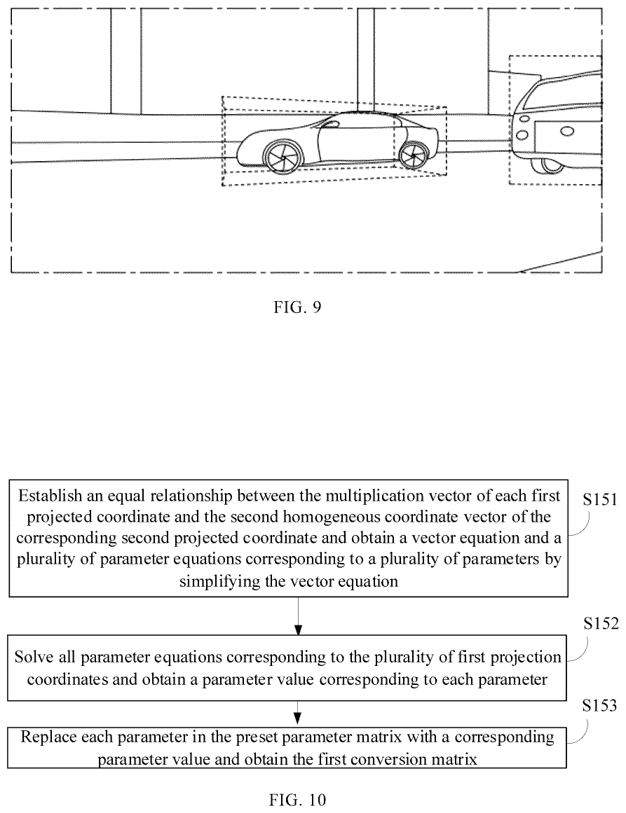

After obtaining the coordinates of the external vehicle, the vehicle-mounted device selects the area of the whole body of the external vehicle from the image of the whole body of the vehicle based on the coordinates of the external vehicle, extracts features of the area of the whole body of the external vehicle, obtains vehicle features, and identifies the vehicle features, and obtains the vehicle information of the external vehicle. For example, as shown in FIG. 9, it is a schematic diagram of an area of a whole body of a vehicle provided by an embodiment of the present application. In FIG. 9, the rectangular area represented by a dotted line is the area of the whole body of the vehicle, and the area of the whole body of the vehicle includes the whole body of the external vehicle.

In this embodiment, the vehicle-mounted device detects the image of the whole body of the external vehicle may ensure the accuracy of detection results such as vehicle information and the vehicle tracking effect.

Through the above embodiments, the first image and the second image are captured by different camera devices. Since different camera devices have different view angles, a first transformation matrix corresponding to the first image is generated according to the first projection coordinate corresponding to each of the plurality of the spatial coordinates and the second projection coordinate corresponding to each of the plurality of the spatial coordinates or a second transformation matrix corresponding to the second image is generated according to the first projection coordinate corresponding to each of the plurality of the spatial coordinates and the second projection coordinate corresponding to each of the plurality of the spatial coordinates; a first conversion image corresponding to the first image is obtained by converting the first image according to the first transformation matrix, and/or a second conversion image corresponding to the second image is obtained by converting the second image according to a second conversion matrix; and an image of a whole body of the external vehicle is generated based on the first converted image and the second image and/or the image of the whole body of the external vehicle is generated based on the second converted image and the first image. Detecting the image of the whole body of the external vehicle may ensure the accuracy of the detection results and the vehicle tracking effect.

In some embodiments of the present application, as shown in FIG. 10, it is a flowchart of a method for calculating a first transformation matrix provided by an embodiment of the present application, which specifically includes the following steps:

In block S151, the vehicle-mounted device establishes an equal relationship between the multiplication vector of each first projected coordinate and the second homogeneous coordinate vector of the corresponding second projected coordinate and obtains a vector equation and a plurality of parameter equations corresponding to a plurality of parameters by simplifying the vector equation.

In some embodiments of the present application, each first projected coordinate corresponds to a plurality of parameter equations.

For example, following the above embodiment, if the preset parameter matrix is

$$[ \begin{matrix}a & b & c \\ d & e & f \\ g & h & i\end{matrix} ] ,$$

the first homogeneous coordinate vector of any first projected coordinate is

$$[ \begin{matrix}{u}_{1} \\ {v}_{1} \\ 1\end{matrix} ] ,$$

and the second homogeneous coordinate vector of the second projected coordinate corresponding to any first projected coordinate is

$$[ \begin{matrix}{u}_{2} \\ {v}_{2} \\ 1\end{matrix} ] ,$$

the vector equations corresponding to the preset parameter matrix

$$[ \begin{matrix}a & b & c \\ d & e & f \\ g & h & i\end{matrix} ] ,$$

the first homogeneous coordinate vector

$$[ \begin{matrix}{u}_{1} \\ {v}_{1} \\ 1\end{matrix} ]$$

and the second homogeneous coordinate vector

$$[ \begin{matrix}{u}_{2} \\ {v}_{2} \\ 1\end{matrix} ]$$

may refer to the formula (1), and the plurality of parameter equations obtained by simplifying the formula (1) may refer to the formula (2) to formula (4):

$$[ \begin{matrix}{u}_{2} \\ {v}_{2} \\ 1\end{matrix} ] = [ \begin{matrix}{u}_{1} \\ {v}_{1} \\ 1\end{matrix} ] \cdot [ \begin{matrix}a & b & c \\ d & e & f \\ g & h & i\end{matrix} ] ; \qquad ( 1 )$$

$${u}_{2} = a {u}_{1} + b {v}_{1} + c ; \qquad ( 2 )$$

$${v}_{2} = d {u}_{1} + e {v}_{1} + f ; \qquad ( 3 )$$

$$1 = g {u}_{1} + h {v}_{1} + i . \qquad ( 4 )$$

In block S152, the vehicle-mounted device solves all parameter equations corresponding to the plurality of first projection coordinates and obtains a parameter value corresponding to each parameter.

In some embodiments of the present application, since each first projected coordinate corresponds to a plurality of parameter equations, all parameter equations obtained through the plurality of first projected coordinates may be used to solve the value corresponding to each parameter and the parameter value corresponding to each parameter may be obtained.

In block S153, the vehicle-mounted device replaces each parameter in the preset parameter matrix with a corresponding parameter value and obtains the first conversion matrix.

In this embodiment, each parameter has a corresponding parameter value, and each parameter value is used to replace the corresponding parameter in the preset parameter matrix, so that the first conversion matrix may be obtained. When the matrix dimension of the preset parameter matrix is 3×3, the matrix dimension of the first conversion matrix is also 3×3.

The present application also provides a computer-readable storage medium, upon which the computer-readable storage medium is encoded with a computer program, wherein such computer program comprises a set of program instructions, and the method implemented when such program instructions are executed may refer to the methods described in each of the implementations of this application.

In one embodiment, the computer-readable storage medium may be an internal storage device of the vehicle-mounted device described in the above embodiment, such as a hard disk or memory of the vehicle-mounted device. The computer-readable storage medium may also be an external storage device of the vehicle-mounted device, such as a plug-in hard drive equipped on the vehicle-mounted device, a smart memory card (SMC), a secure digital (SD) card, a flash memory card (Flash Card), etc.

In some embodiments, the computer-readable storage medium may include an area for storing program and an area for storing data, wherein the area for storing program may store an operating system, at least one application program required for a function, etc. There for storing data is capable of storing data wrought according to the utilization of the vehicle-mounted device.

In the above embodiments, each embodiment is described with its own emphasis. For parts that are not detailed or documented in a certain embodiment, please refer to the relevant descriptions of other embodiments.

In the several embodiments provided in this application, it should be understood that the disclosed systems, devices and methods may be implemented in other ways. For example, the device embodiments described above are only illustrative. For example, the division of modules is only a logical function division, and there may be other division methods in actual implementation.

The modules described as separate components may or may not be physically separated, and the components shown as modules may or may not be physical units, that is, they may be located in one place, or they may be distributed to a plurality of network units. Some or all of the modules may be selected according to actual needs to achieve the purpose of the solution of this embodiment. In addition, each functional module in various embodiments of the present application may be integrated into one processing unit, or each unit may exist physically alone, or two or more units may be integrated into one unit. The above-mentioned integrated unit may be implemented in the form of hardware or in the form of hardware plus software function modules.

Therefore, the embodiments should be regarded as illustrative and non-restrictive from any point of view, and the scope of the application is defined by the depended claims rather than the above description, and it is therefore intended that all claims falling within the claims All changes within the meaning and scope of the equivalent elements are included in this application. Any accompanying reference signs in the claims shall not be construed as limiting the claim in question. Furthermore, it is clear that the word “comprising” does not exclude other elements or steps, and the singular does not exclude the plural. A plurality of units or devices stated in this application may also be implemented by one unit or device through software or hardware. The words first, second, etc. are used to indicate names and do not indicate any specific order.

Finally, it should be noted that the above embodiments are only used to illustrate the technical solutions of the present application and are not limiting. Although the present application has been described in detail with reference to the preferred embodiments, those of ordinary skill in the art should understand that the technical solutions of the present application may be modified. Modifications or equivalent substitutions may be made without departing from the spirit and scope of the technical solution of the present application.

What is claimed is:

1. An image processing method using a vehicle-mounted device, the method comprising:
acquiring a plurality of images of an external vehicle out of a current vehicle, the plurality of images comprising a first image of a front part of the external vehicle acquired by using a first camera device and a second image of a rear part of the external vehicle acquired by using a second camera device, a first view angle of the first camera device being different from a second view angle of the second camera device;
determining a target visual plane based on a first shooting field of view of the first camera device and a second shooting field of view of the second camera device and obtaining a plurality of spatial coordinates of a plurality of vertices of the target visual plane;
projecting each of the plurality of the spatial coordinates into a first coordinate system of the first image and obtaining a first projection coordinate corresponding to each of the plurality of the spatial coordinates, and projecting each of the plurality of the spatial coordinates into a second coordinate system of the second image and obtaining a second projection coordinate corresponding to each of the plurality of the spatial coordinates;
generating a first transformation matrix corresponding to the first image according to the first projection coordinate corresponding to each of the plurality of the spatial coordinates and the second projection coordinate corresponding to each of the plurality of the spatial coordinates and/or generating a second transformation matrix corresponding to the second image according to the first projection coordinate corresponding to each of the plurality of the spatial coordinates and the second projection coordinate corresponding to each of the plurality of the spatial coordinates;
obtaining a first conversion image corresponding to the first image by converting the first image according to the first transformation matrix, and/or obtaining a second conversion image corresponding to the second image by converting the second image according to a second conversion matrix; and
generating an image of a whole body of the external vehicle based on the first converted image and the second image and/or generating the image of the whole body of the external vehicle based on the second converted image and the first image.

2. The image processing method according to claim 1, wherein the target visual plane is in an overlapping space area between the first shooting field of view and the second shooting field of view.

3. The image processing method according to claim 1, wherein projecting each of the plurality of the spatial coordinates into the first coordinate system of the first image and obtaining the first projection coordinate corresponding to each of the plurality of the spatial coordinates comprises:
projecting each of the plurality of the spatial coordinates into the first coordinate system of the first image by using an orthogonal projection method or a perspective projection method, and
obtaining the first projection coordinate corresponding to each of the plurality of the spatial coordinates.

4. The image processing method according to claim 1, wherein generating the first transformation matrix corresponding to the first image according to the first projection coordinate corresponding to each of the plurality of the spatial coordinates and the second projection coordinate corresponding to each of the plurality of the spatial coordinates comprises:
obtaining a multiplication vector of each first projection coordinate by multiplying a first homogeneous coordinate vector of each first projection coordinate with a preset parameter matric; and
generating the first transformation matrix based on the multiplication vector and a second homogeneous coordinate vector of the second projection coordinate corresponding to the multiplication vector.

5. The image processing method according to claim 4, wherein the preset parameter matrix comprises a plurality of parameters, generating the first transformation matrix based on the multiplication vector and the second homogeneous coordinate vector of the second projection coordinate corresponding to the multiplication vector comprises:
establishing an equal relationship between the multiplication vector of each first projected coordinate and the second homogeneous coordinate vector of the corresponding second projected coordinate and obtaining a vector equation;
obtaining a plurality of parameter equations corresponding to the plurality of parameters by simplifying the vector equation;
solving the plurality of parameter equations corresponding to the plurality of first projection coordinates and obtaining a parameter value corresponding to each of the plurality of parameters; and
replacing each parameter in the preset parameter matrix with a corresponding parameter value and obtaining the first conversion matrix.

6. The image processing method according to claim 1, wherein obtaining a first conversion image corresponding to the first image by converting the first image according to the first transformation matrix comprises:
determining a first target coordinate corresponding to each first initial coordinate by multiplying a homogeneous coordinate vector corresponding to a first initial value of each pixel of the first image by the first transformation matrix; and
replacing a pixel value of a pixel of each first target coordinate of the first image with a pixel value of a pixel of the first initial coordinate and obtaining the first converted image.

7. The image processing method according to claim 1, wherein generating an image of a whole body of the external vehicle based on the first converted image and the second image comprises:
cropping a first overlapping area between the first converted image and the second image from the first converted image and obtaining a first cropped image; and
splicing the first cropped image and the second image and obtaining the image of the whole body of the external vehicle.

8. A vehicle-mounted device comprising:
a storage device;
at least one processor; and
the storage device storing one or more programs, which when executed by the at least one processor, cause the at least one processor to:
acquire a plurality of images of an external vehicle out of a current vehicle, the plurality of images comprising a first image of a front part of the external vehicle acquired by using a first camera device and a second image of a rear part of the external vehicle acquired by using a second camera device, a first view angle of the first camera device being different from a second view angle of the second camera device;
determine a target visual plane based on a first shooting field of view of the first camera device and a second shooting field of view of the second camera device and obtain a plurality of spatial coordinates of a plurality of vertices of the target visual plane;
project each of the plurality of the spatial coordinates into a first coordinate system of the first image and obtain a first projection coordinate corresponding to each of the plurality of the spatial coordinates, and project each of the plurality of the spatial coordinates into a second coordinate system of the second image and obtain a second projection coordinate corresponding to each of the plurality of the spatial coordinates;
generate a first transformation matrix corresponding to the first image according to the first projection coordinate corresponding to each of the plurality of the spatial coordinates and the second projection coordinate corresponding to each of the plurality of the spatial coordinates and/or generate a second transformation matrix corresponding to the second image according to the first projection coordinate corresponding to each of the plurality of the spatial coordinates and the second projection coordinate corresponding to each of the plurality of the spatial coordinates;
obtain a first conversion image corresponding to the first image by converting the first image according to the first transformation matrix, and/or obtain a second conversion image corresponding to the second image by converting the second image according to a second conversion matrix; and
generate an image of a whole body of the external vehicle based on the first converted image and the second image and/or generate the image of the whole body of the external vehicle based on the second converted image and the first image.

9. The vehicle-mounted device according to claim 8, wherein the target visual plane is in an overlapping space area between the first shooting field of view and the second shooting field of view.

10. The vehicle-mounted device according to claim 8, wherein the at least one processor projects each of the plurality of the spatial coordinates into the first coordinate system of the first image and obtains the first projection coordinate corresponding to each of the plurality of the spatial coordinates by:
projecting each of the plurality of the spatial coordinates into the first coordinate system of the first image by using an orthogonal projection method or a perspective projection method, and
obtaining the first projection coordinate corresponding to each of the plurality of the spatial coordinates.

11. The vehicle-mounted device according to claim 8, wherein the at least one processor generates the first transformation matrix corresponding to the first image according to the first projection coordinate corresponding to each of the plurality of the spatial coordinates and the second projection coordinate corresponding to each of the plurality of the spatial coordinates by:
obtaining a multiplication vector of each first projection coordinate by multiplying a first homogeneous coordinate vector of each first projection coordinate with a preset parameter matric; and
generating the first transformation matrix based on the multiplication vector and a second homogeneous coordinate vector of the second projection coordinate corresponding to the multiplication vector.

12. The vehicle-mounted device according to claim 11, wherein the preset parameter matrix comprises a plurality of parameters, the least one processor generates the first transformation matrix based on the multiplication vector and the second homogeneous coordinate vector of the second projection coordinate corresponding to the multiplication vector by:
establishing an equal relationship between the multiplication vector of each first projected coordinate and the second homogeneous coordinate vector of the corresponding second projected coordinate and obtaining a vector equation;
obtaining a plurality of parameter equations corresponding to the plurality of parameters by simplifying the vector equation;
solving the plurality of parameter equations corresponding to the plurality of first projection coordinates and obtaining a parameter value corresponding to each of the plurality of parameters; and
replacing each parameter in the preset parameter matrix with a corresponding parameter value and obtaining the first conversion matrix.

13. The vehicle-mounted device according to claim 11, wherein the at least one processor obtains a first conversion image corresponding to the first image by converting the first image according to the first transformation matrix by:
determining a first target coordinate corresponding to each first initial coordinate by multiplying a homogeneous coordinate vector corresponding to a first initial value of each pixel of the first image by the first transformation matrix; and
replacing a pixel value of a pixel of each first target coordinate of the first image with a pixel value of a pixel of the first initial coordinate and obtaining the first converted image.

14. The vehicle-mounted device according to claim 8, wherein the at least one processor generates an image of a whole body of the external vehicle based on the first converted image and the second image by:
cropping a first overlapping area between the first converted image and the second image from the first converted image and obtaining a first cropped image; and
splicing the first cropped image and the second image and obtaining the image of the whole body of the external vehicle.

15. A non-transitory storage medium having instructions stored thereon, when the instructions are executed by a processor of a vehicle-mounted device, the processor is caused to perform an image processing method, wherein the method comprises:
acquiring a plurality of images of an external vehicle out of a current vehicle, the plurality of images comprising a first image of a front part of the external vehicle acquired by using a first camera device and a second image of a rear part of the external vehicle acquired by using a second camera device, a first view angle of the first camera device being different from a second view angle of the second camera device;
determining a target visual plane based on a first shooting field of view of the first camera device and a second shooting field of view of the second camera device and obtaining a plurality of spatial coordinates of a plurality of vertices of the target visual plane;
projecting each of the plurality of the spatial coordinates into a first coordinate system of the first image and obtaining a first projection coordinate corresponding to each of the plurality of the spatial coordinates, and projecting each of the plurality of the spatial coordinates into a second coordinate system of the second image and obtaining a second projection coordinate corresponding to each of the plurality of the spatial coordinates;
generating a first transformation matrix corresponding to the first image according to the first projection coordinate corresponding to each of the plurality of the spatial coordinates and the second projection coordinate corresponding to each of the plurality of the spatial coordinates and/or generating a second transformation matrix corresponding to the second image according to the first projection coordinate corresponding to each of the plurality of the spatial coordinates and the second projection coordinate corresponding to each of the plurality of the spatial coordinates;
obtaining a first conversion image corresponding to the first image by converting the first image according to the first transformation matrix, and/or obtaining a second conversion image corresponding to the second image by converting the second image according to a second conversion matrix; and
generating an image of a whole body of the external vehicle based on the first converted image and the second image and/or generating the image of the whole body of the external vehicle based on the second converted image and the first image.

16. The non-transitory storage medium according to claim 15, wherein the target visual plane is in an overlapping space area between the first shooting field of view and the second shooting field of view.

17. The non-transitory storage medium according to claim 15, wherein projecting each of the plurality of the spatial coordinates into the first coordinate system of the first image and obtaining the first projection coordinate corresponding to each of the plurality of the spatial coordinates comprises:
projecting each of the plurality of the spatial coordinates into the first coordinate system of the first image by using an orthogonal projection method or a perspective projection method, and
obtaining the first projection coordinate corresponding to each of the plurality of the spatial coordinates.

18. The non-transitory storage medium according to claim 15, wherein generating the first transformation matrix corresponding to the first image according to the first projection coordinate corresponding to each of the plurality of the spatial coordinates and the second projection coordinate corresponding to each of the plurality of the spatial coordinates comprises:
obtaining a multiplication vector of each first projection coordinate by multiplying a first homogeneous coordinate vector of each first projection coordinate with a preset parameter matric; and
generating the first transformation matrix based on the multiplication vector and a second homogeneous coordinate vector of the second projection coordinate corresponding to the multiplication vector.

19. The non-transitory storage medium according to claim 18, wherein the preset parameter matrix comprises a plurality of parameters, generating the first transformation matrix based on the multiplication vector and the second homogeneous coordinate vector of the second projection coordinate corresponding to the multiplication vector comprises:
establishing an equal relationship between the multiplication vector of each first projected coordinate and the second homogeneous coordinate vector of the corresponding second projected coordinate and obtaining a vector equation;
obtaining a plurality of parameter equations corresponding to the plurality of parameters by simplifying the vector equation;
solving the plurality of parameter equations corresponding to the plurality of first projection coordinates and obtaining a parameter value corresponding to each of the plurality of parameters; and
replacing each parameter in the preset parameter matrix with a corresponding parameter value and obtaining the first conversion matrix.

20. The non-transitory storage medium according to claim 15, wherein obtaining a first conversion image corresponding to the first image by converting the first image according to the first transformation matrix comprises:
determining a first target coordinate corresponding to each first initial coordinate by multiplying a homogeneous coordinate vector corresponding to a first initial value of each pixel of the first image by the first transformation matrix; and
replacing a pixel value of a pixel of each first target coordinate of the first image with a pixel value of a pixel of the first initial coordinate and obtaining the first converted image.
